(19) United States
(12) Patent Application Publication
(10) Pub. No.: US 2004/0061451 A1
(43) Pub. Date: Apr. 1, 2004

(54) Circuit device designed to regulate voltage by capacitive reactance for illuminating christmas ornamental lights

(76) Inventor: Rong-Fang Tung, Grangshan Jen (TW)

Correspondence Address: Raymond Y. Chan, Suite 128, 108 N. Ynez Avenue, Monterey Park, CA, 91754, US

(21) Appl. No.: 10/259,886

(22) Filed: Sep. 30, 2002

(51) Int. Cl. H05B 41/00

(52) U.S. Cl. 315/185 R; 315/185 S

(57) ABSTRACT

A circuit device is designed to illuminate a series of Christmas ornamental lights in conjunction with a plug and an integrated circuit control box. The circuit device is formed of a resistor and two serially-connected capacitors which are linked to the resistor in parallel connection for bringing about a capacitive reactance serving to lower a voltage of an external alternating current to an extent that the voltage is suitable for operation of the integrated circuit control box.

### FIELD OF THE PRESENT INVENTION

The present invention relates generally to a circuit device, and more particularly to a circuit device which is used in conjunction with an IC controller for illuminating a series of Christmas ornamental lights in a variety of flashing patterns.

### BACKGROUND OF THE PRESENT INVENTION

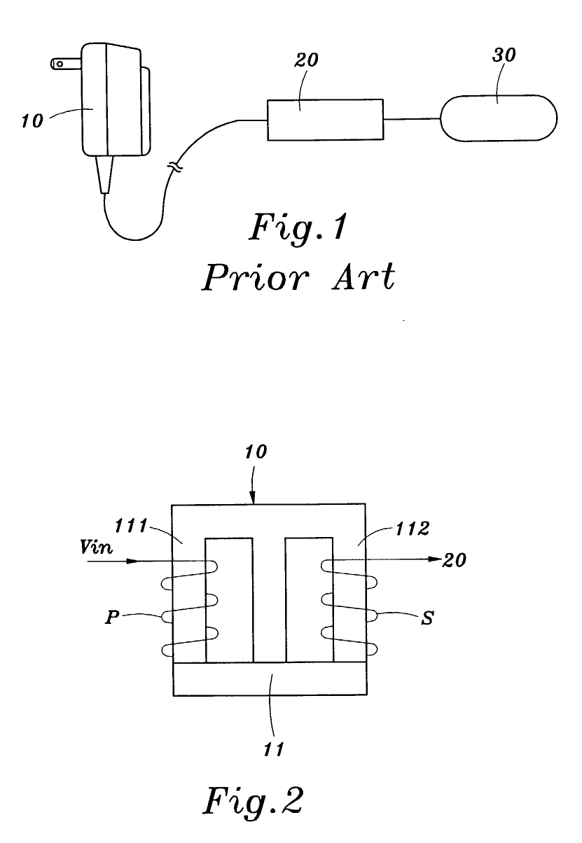

As illustrated in FIG. 1, the conventional device for illuminating a series of Christmas ornamental lights 30 comprises an alternating current adapter 10 and an IC control box 20. The AC adapter 10 is used to regulate the voltage of an external power source of alternating current such that the external power source of 110 volts or 220 volts is transformed into a power source of 24 volts, which is thus usable to the IC control box 20 for controlling the flashing patterns of the Christmas ornamental lights 30. The alternating current adapter 10 has several shortcomings, which are described hereinafter with reference to FIG. 2.

The alternating current adapter 10 has a core 11 which is formed of a plurality of silicon steel laminas. The core 11 has two sides 111 and 112, which are respectively provided with a primary winding (P), and a secondary winding (S). The primary winding and the secondary winding are different in number of turns. The primary winding is connected to an external alternating current power source, whereas the secondary winding is connected to the IC control box 20. As soon as the primary winding is connected with the external alternating current power source, a magnetic flux φ is induced. With the core 11 serving as a loop, the magnetic flux φ passes the secondary winding such that an induction voltage and an induction current are induced on the secondary winding. The function of the induction voltage of the secondary winding is increased or reduced by an increase or reduction in number of turns of the secondary winding, thereby resulting in a voltage value that is suitable for the IC control box 20. The core 11 is therefore an indispensable element of the alternating current adapter 10. The core 11 is relatively large in volume as compared with resistor, transistor, integrated circuit, and the like. In light of the cumbersome volume of the core 11, the alternating current adopter 10 can not be mounted on a circuit board along with other electronic components. As a result, the alternating current adapter 10 must exist as an independent unit. In another words, a series of Christmas ornamental lights 30 must be provided exclusively with one adapter 10. Accordingly, a large number of the adapters 10 must be produced. In addition, the adapter 10 and the Christmas ornamental lights 30 must be packaged separately so as to prevent the ornamental lights 30 from being damaged by the AC adapter 10 in the course of transportation. It is therefore readily apparent that the conventional device as described above is not cost-effective.

### SUMMARY OF THE PRESENT INVENTION

It is the primary objective of the present invention to provide a circuit device which is designed to regulate voltage by capacitive reactance for illuminating a series of Christmas ornamental lights. The capacitive reactance is brought about by a plurality of capacitors.

The circuit device of the present invention is so miniaturized that it can be mounted in a plug or IC control box of the Christmas ornamental lights, thereby resulting in a substantial reduction in cost of making, packaging and transporting the product.

The features and the advantages of the present invention will be more readily understood upon a thoughtful deliberation of the following detailed description of a preferred embodiment of the present invention with reference to the accompanying drawings.

### DETAILED DESCRIPTION BRIEF DESCRIPTION OF DRAWINGS

FIG. 1 shows a schematic view of the assembly of a conventional set of Christmas ornamental lights.

FIG. 2 shows a schematic view of the structure of an alternating current adapter of the conventional set of Christmas ornamental lights as shown in FIG. 1.

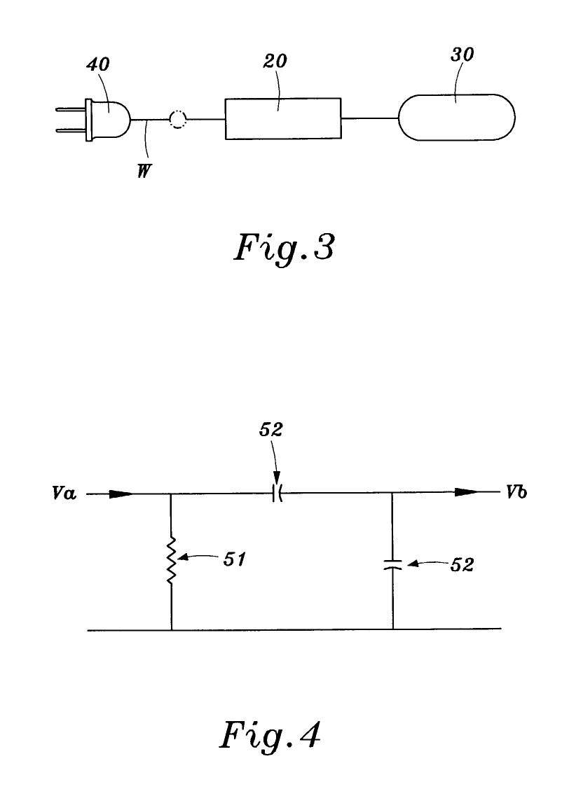

FIG. 3 shows a schematic view of the present invention which is denoted by a dotted circle and is mounted on a bonding wire “W” between a plug and an IC control box.

FIG. 4 shows a circuit diagram of the present invention.

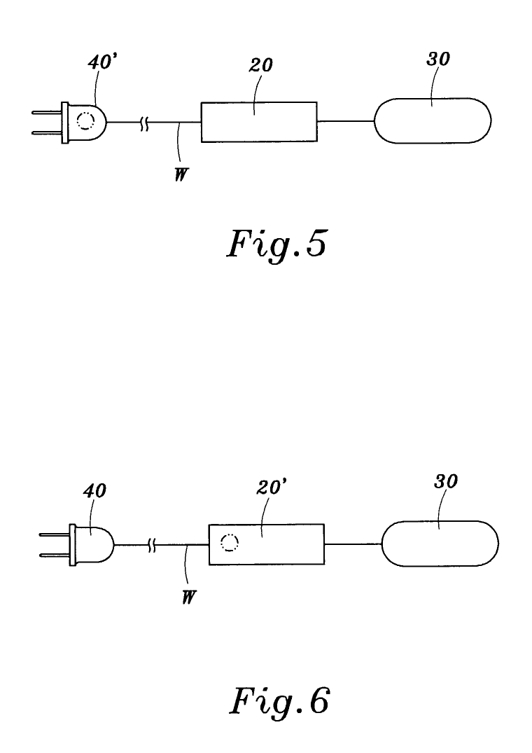

FIG. 5 shows a schematic view of the present invention which is mounted in the interior of a plug.

FIG. 6 shows a schematic view of the present invention which is mounted in the interior of an IC control box.

### DETAILED DESCRIPTION OF THE PREFERRED EMBODIMENT

As shown in FIGS. 3 and 4, a circuit device (denoted by a dotted circle) of the present invention is mounted on a bonding wire “W” between a plug 40 and an IC control box 20. The circuit device of the present invention is formed of a resistor 51 and two capacitors 52 which are linked with the resistor 51 in parallel connection. The resistor 51 serves to determine the amount of electrical current that is allowed to flow through the circuit. The two capacitors 52 are serially connected and are used to determine the magnitude of a capacitive reactance of the circuit. As an external alternating current passes through the resistor 51 and the two capacitors 52 via the plug 40 and the bonding wire “W” a capacitive reactance is brought about by the two capacitors 52. The capacitive reactance servers to lower the voltage (Va) of the external alternating current to a voltage (Vb) which is needed for the operation of the IC control box 30.

Assuming that the external alternating current has a frequency of 60 HZ and a voltage of 110 volts, and that the resistor 51 has a resistance of 120,000 ohms (Ω), and further that the two capacitors 52 have a capacitance of 2 μF, an electrical current value is brought about as the flow of the external alternating current through the resistor 51 takes place. The electrical current value is calculated by a formula as follows:

V=I×R

110(volts)=I(ampere)×120,000(ohms)

I=9.1×10⁻⁴ ampere(A)

The value of the capacitance of the two serially-connected capacitors 52 is calculated by a formula as follows:

$$\begin{matrix}C = C1 \times C2 / C1 + C2 \\ \begin{matrix}C = ( 2 \times 2 ) / ( 2 + 2 ) \\ = 1 μ F\end{matrix}\end{matrix}$$

The capacitive reactance (Xc) has an equation as follows:

$$\begin{matrix}Xc = 1 / 2 π f C \\ = 1 / 2 π \times 60 \times 1 \times {10}^{- 6} \\ = 2653 ohms\end{matrix}$$

The letter f of the above equation stands for the frequency of the external alternating current.

Moreover, Xc=Ec/Ic. As a result, Ec=Xc×Ic. Accordingly, Ec=2653 ohms×9.1×10⁻⁴ ampere=24 volts. Ic stands for the current in the circuit, whereas Ec stands for the voltage value which is brought about in the wake of the flow of the current through the capacitive reactance Xc.

On the basis of the above calculations, it is readily apparent that the circuit device of the present invention is capable of attaining a result that is expected.

The embodiment of the present invention described above is to be construed in all respects as being merely illustrative and nonrestrictive. Accordingly, the present invention may be embodied in other specific forms without deviating from the spirit thereof. For example, the circuit device (denoted by a dotted circle) of the present invention may be disposed in the interior of a plug 40′, as shown in FIG. 5, or in the interior of an IC control box 20′, as shown in FIG. 6. The present invention is therefore to be limited only by the scopes of the following claims.

What is claimed is:

1. A circuit device designed to illuminate a series of Christmas ornamental lights in conjunction with an integrated circuit (IC) control box, and a plug which is used to make an external alternating current available to said circuit device and is connected with the IC control box by a bonding wire whereby said circuit device is disposed on the bonding wire and is formed of a resistor, and two serially-connected capacitors which are linked to said resistor in parallel connection for bringing about a capacitive reactance serving to lower a voltage of the external alternating current to an extent that the voltage is suitable for operation of the IC control box.

2. The circuit device as defined in claim 1, wherein said circuit device is disposed in the interior of the plug.

3. The circuit device as defined in claim 1, wherein said circuit device is disposed in the interior of the IC control box.
